(19) United States
(12) Patent Application Publication
(10) Pub. No.: US 2022/0374392 A1
(43) Pub. Date: Nov. 24, 2022

(54) Method For Applying Local Volume File System Policies(encryption, compression and etc) on Cloud(HTTP(S) Server) Files

(71) Applicant: Ramakrishnan Samy, Sattur (IN)

(72) Inventor: Ramakrishnan Samy, Sattur (IN)

(21) Appl. No.: 17/562,016

(22) Filed: Dec. 27, 2021

Related U.S. Application Data
(60) Provisional application No. 63/191,381, filed on May 21, 2021.

(51) Int. Cl. G06F 16/11; G06F 16/182; H04L 67/06; H04L 69/18

(52) U.S. Cl. CPC G06F 16/122; G06F 16/183; H04L 67/06; H04L 69/18

(57) ABSTRACT

The user can apply the local volume file system policies like encryption/decryption, file, backup, antivirus, file compression/decompression, file monitoring and etc to the cloud (HTTPS server) files:

The cloud (HTTPS server) files are not vulnerable to man in the middle attack when they are on the way to the cloud (HTTPS server) from the local computer and vice versa, since the files are secured by local volume file system policies (encryption/decryption) in the local computer before they are stored in the cloud (HTTPS server).

The user need not to rely on the cloud (HTTPS server) for the security of the cloud (HTTPS server) files, since the: files are secured by local volume file system policies (encryption/decryption) in the local computer before they are stored in the cloud (HTTPS Server).

### CROSS-REFERENCE TO RELATED APPLICATIONS

Provisional Patent Application No.: 63191381

### BACKGROUND OF THE INVENTION

When a file is accessed from a volume using a file system driver, the modules responsible for local volume file system policies (for example Windows file system filter drivers), can apply the file encryption/decryption, file backup, antivirus, file Compression/decompression, file monitoring and etc policies on the file.

When a file is accessed from the cloud (HTTPS server) using HTTPS protocol, the file is accessed by HTTPS GET and HTTPS POST/PUT requests over network. Since the file access does not involve the file system driver, the modules responsible for local volume file system policies, cannot apply the file system policies, on the cloud (HTTPS server) files.

The user cannot apply the file encryption/decryption, file backup, antivirus, file compression/decompression, file monitoring and etc policies on the cloud (HTTPS server) files.

The user cannot apply the local volume file system policies on the files in the following cases
1. When the files are only stored in the cloud.
2. When the applications (for example Microsoft Office applications) are not installed in the local computer and the web versions of the applications (for example Microsoft Office applications) are used.

Example: Local Volume File System Policies in Windows

FIG. 1 depicts how the local volume file system policies are applied in Windows
When a file system driver is loaded for a volume, the file system filter drivers installed on the local computer, will be loaded on top of the file system driver.
A file in the volume is accessed by an application using system calls (create, open, read, write, close and etc) to the file.
IO manager (a windows component) converts the system calls into IRPs, sends the IRPs to the file system driver for processing, receives back the IRPs from the file system driver after processing and completes the system calls made by the application after the IRPs are processed by the file system driver

Example: Local Volume File System Policies in Windows

The file system filter drivers loaded on top of the file system driver, intercept the IRPs going to the file system driver from IO manager and coming back from file system driver to IO manager and apply the file system filter driver policies like monitoring, anti virus, backup, compression/decompression, encryption/decryption and etc.

Thus file system filter driver policies are applied to the files in the volume.

HTTPS File Transfer Between HTTPS Server and HTTPS Client

FIG. 2 depicts how the file is transferred between HTTPS server and HTTPS client.

When a file in the cloud (HTTPS server) is accessed by a HTTPS client, the cloud (HTTPS server) and the HTTPS client, use HTTPS GET request and response and HTTPS POST/PUT request over network to transfer the file contents.

The local volume file system policies will not be applied on the files in the cloud (HTTPS server), since the file is accessed through network and the modules responsible for local volume file system policies, will not play any role.

HTTPS File Transfer Between HTTPS Server and HTTPS Client

The files are stored in the cloud (HTTPS server) by the HTTPS client application using the following HTTPS command sequence
1) HTTPS POST/PUT path_to_file file_content

where path_to_file is full path to the file and file_content is the -contents of the file, is sent from client to-server.

HTTPS File Transfer Between HTTPS Server and HTTPS Client

The files are retrieved from the cloud (HTTPS server) by the HTTPS client application using the following HTTPS command sequence
1) HTTPS GET path_to_file where path_to_file is full path to file, is sent from client to server.
2) HTTPS GET path_to_file response file_content.

where path_to_file is full path to file and file_content is the contents of the file, is sent from server to client.

### BRIEF SUMMARY OF THE INVENTION

Provisions the user to apply local volume file system policies on cloud (HTTPS server) files, when the cloud (HTTPS server) files are accessed using HTTPS protocol.

The local volume file system policies include file encryption/decryption, file backup, antivirus, file compression/decompression, file monitoring and etc.

### BRIEF DESCRIPTION OF DRAWINGS

FIG. 1 depicts how the local volume file system policies: are applied in Windows.

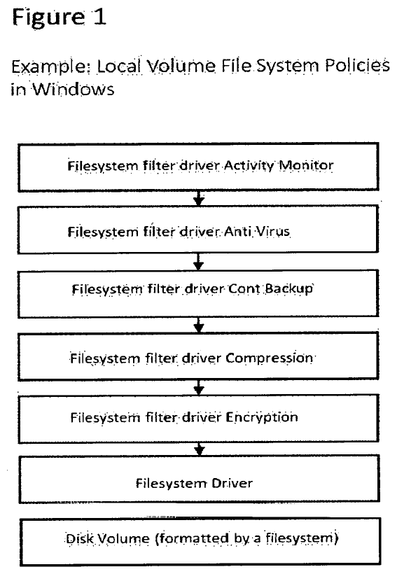

FIG. 2 depicts how the file is transferred between HTTPS server and HTTPS client.

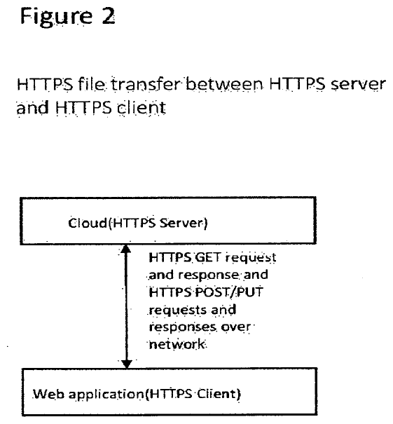

FIG. 3 depicts the HTTPS session redirection and on behalf session establishment.

FIG. 4 depicts the HTTPS POST/PUT Flow.

FIG. 5 depicts the HTTPS GET Flow.

### DETAILED DESCRIPTION OF THE INVENTION

We can apply the local volume file system policies to the cloud (HTTP Server) files by adding the following three modules in the local computer
Cloud Traffic Redirector.
Cloud File IO Filter
Cloud File IO Manager

Cloud Traffic Redirector

A network filter in user or kernel mode (Can be WFP callout driver in windows, a netfilter/iptable module in linux, a netfilter/iptable module in android)

Intercepts the incoming and outgoing HTTPS packets and the incoming DNS packets.

Gets the IP address of the cloud (HTTPS server) (example—onedrive.live.com) by looking into the incoming DNS packets.

When a HTTPS client application sends HTTPS traffic to the cloud (HTTPS server), the destination IP address and port are updated with the IP address and port of the cloud file io manager. Thus the traffic to the cloud (HTTPS server) is redirected to the cloud file io manager.

When the cloud file io manager sends HTTPS traffic to a HTTPS client application, the source IP address and port are updated with the IP address and port of the cloud (HTTPS server). Thus the HTTPS traffic appears to be from the cloud (HTTPS server) for the HTTPS client application.

Creates the special folder c:\FS_POLICIES_FOR_CLOUD or a volume X:\ with removable volume properties.

Cloud File IO Filter

Intercepts system calls after the local volume file system policies are applied and before the system calls reaches the file system driver (Can be a file system filter driver with FSFILTER BOTTOM class in windows, a REDIRFS based file system filter driver in linux, a module using FileObserver class in android).

Intercepts and processes the file open (create/open), file read, file write and file close requests targeted for the files inside the special folder (c:\FS_POLICIES_FOR_CLOUD) and bypasses the file requests to other volumes and folders or intercepts and processes the file open (create/open), file read, file write and file close requests targeted for the files inside the special volume (X:\) and bypasses the file requests to other volumes.

File io requests to special folders can be initiated by cloud file IO manager and the modules responsible for local volume file system policies. The cloud file IO filter has to handle the file io requests initiated by both cloud file IO manager and the modules responsible for local volume file system policies.

Completes the file open (create/open) and file close operations with status success.

Sends the file contents of file write operations to the cloud file IO manager and completes the file write request with success status.

Pends the read operations and completes them with success status when the file contents received from the cloud file IO manager.

Cloud File IO Manager

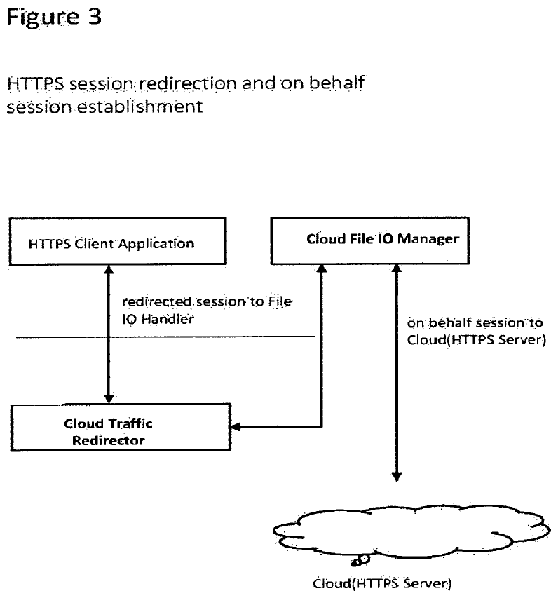

FIG. 3 depicts the HTTPS session redirection and on behalf session establishment.

A local proxy server or a common remote proxy server for a set of users

When a HTTPS client application tries to establish a session with the cloud (HTTPS server), the request is redirected to the cloud file io manager, the cloud file io manager establishes a redirected session with the HTTPS client application, establishes a on behalf session with the cloud (HTTP server) using the same credentials obtained form the redirected session and creates a special folder for the session (c:\FS_POLICIES_FOR_CLOUD\onedrive_files or X:\onedrive_files).

When a HTTPS client application tries to close a session with the cloud (HTTPS server), the request is redirected, to the cloud file io manager, the cloud file io manager closes the redirected session with the HTTPS client application, closes the on behalf session with the cloud (HTTP server) and deletes the special folder (c:\FS_POLICIES_FOR_CLOUD\onedrive_files or X:\onedrive_files).

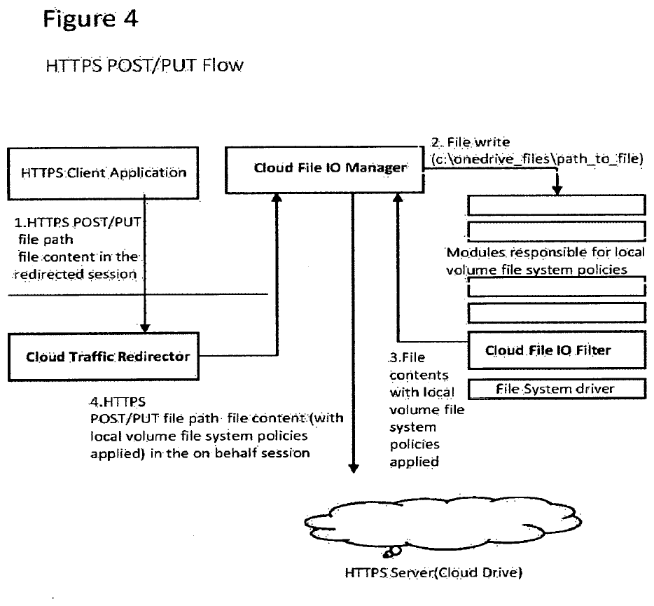

FIG. 4 depicts the HTTPS POST/PUT Flow.

When a HTTPS POST/PUT path_to_file file_content request is received in the redirected session, the cloud file io manager does a file create (for HTTPS POST) request or a file open (for HTTPS PUT) request With the file name c:\FS_POLICIES_FOR_CLOUD:\onedrive_files\path_to_file.

The cloud file io filter completes the file create or file open request with success.

Then the cloud file io manager does a file write request with the file_content.

The file write request goes through the file system driver stack which includes the modules responsible for local volume file system policies and these modules apply the local volume file system policies on the file_content.

The cloud file io filter sends the file_content to the cloud file io manager and completes the file write request with success.

Then the cloud file io manager sends the HTTPS POST/PUT path_to_file file_content (with local volume file system policies applied) request to the cloud (HTTPS server) in the on behalf session.

Then the cloud file io manager does a file close request.

The cloud file io filter completes the file close request with success.

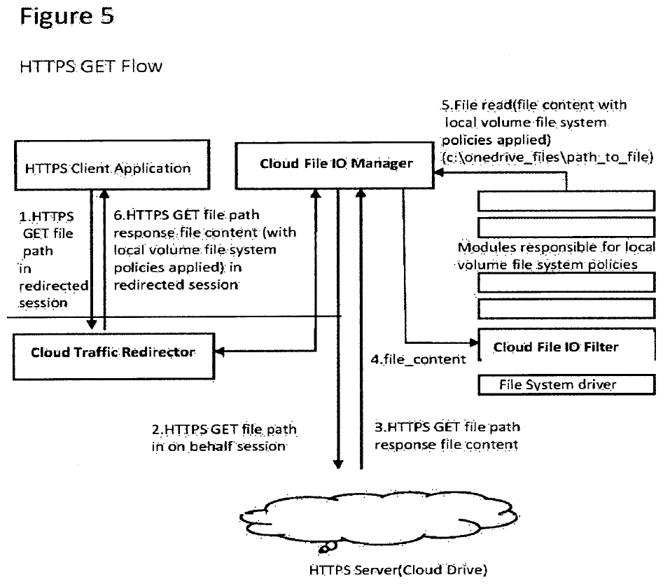

FIG. 5 depicts the HTTPS GET Flow.

When a HTTPS GET path_to_file request is received in the redirected session, the cloud file io manager sends a HTTPS GET path_to_file request to the cloud (HTTPS server) in the on behalf session.

Then the cloud file io manager does a file open request with the file name c:\FS_POLICIES_FOR_CLOUD\onedrive_files\path_to_file.

The cloud file io filter completes the file open request with success.

Then the cloud file io manager does a file read request.

When the HTTPS GET path_to_file response file_content is received in the on behalf session, the cloud file io manager sends the file_content to the cloud file io filter.

The cloud file io filter completes the file read request with the file_content.

The completed file read request goes through the file system driver stack which includes the modules responsible for local volume file system policies and these modules apply the local volume file System policies on the file_content.

The read request initiated by the cloud file io manager is completed with the file_content with local volume file system policies applied.

Then the cloud file io manager sends the HTTPS GET path_to_file response file_content (with local volume file system policies applied) to the HTTPS client application in the redirected session.

Then the cloud file io manager does a file close request.

The cloud file io filter completes the file close request with success.

The cloud file io manager need not to be a local proxy server in case of HTTP server or HTTPS offloaded to network card. In these cases the cloud traffic redirector can act as the cloud file io manager, since the cloud traffic redirector can directly intercept the HTTP request and responses (without HTTPS encryption).

In these cases the cloud file io manager uses the same session initiated by a HTTP client application to communicate with the cloud (HTTP(S) server). In other words the session initiated by a HTTPS client application to cloud (HTTPS server), acts as both redirected and on behalf session.

The file operations initiated by the cloud file io manager, can be cached or noncached. In case of cached operations, files should be flushed after every write, so that changes to the files are reflected immediately in the cloud.

When the cloud file io manager is a common remote proxy server for a set of users, a common file system policies can be applied for the set of users. So that the files can be easily shared between the set of users.

If the cloud traffic redirector creates a removable volume (X:\), the files inside the volume X:\ are encrypted and decrypted irrespective of local machine. So that the files can be accessed from different machines, if the same encryption and decryption configuration is used.

1. By intercepting the file transfer requests with HTTP(S), FTP, CIFS, WebDAV, samba and NFS protocols to the file server, completing the intercepted file transfer requests with filesystem calls to dummy local folder or dummy local volume, intercepting the filesystem calls to the dummy local volume or dummy local folder after the modules responsible for local volume file system policies processed the filesystem calls and making the file transfer to file server after the modules responsible for local volume file system policies processed the filesystem calls, the client can apply the local volume file system policies like encryption/decryption, file backup, antivirus, file compression/decompression and file monitoring, to the files in the file server. The HTTP(S), FTP, CIFS, WebDAV, samba and NFS applications need not to be modified since the file transfer is intercepted and local volume filesystem policies are applied on the fly.
